(19) United States
(12) Patent Application Publication
(10) Pub. No.: US 2026/0312116 A1
(43) Pub. Date: Oct. 8, 2026

(54) SECONDARY BATTERY, SECONDARY BATTERY MANUFACTURING DEVICE, AND METHOD OF MANUFACTURING A SECONDARY BATTERY

(71) Applicant: SAMSUNG SDI CO., LTD., Yongin-si (KR)

(72) Inventor: YOHAN JEONG, Yongin-si (KR)

(21) Appl. No.: 19/352,668

(22) Filed: Oct. 8, 2025

(30) Foreign Application Priority Data
Apr. 8, 2025 (KR) 10-2025-0045332

(51) Int. Cl. H01M 10/04

(52) U.S. Cl. CPC H01M 10/0431

(57) ABSTRACT

A secondary battery manufacturing device may include a winder that is rotatable in one direction and winds electrode plates and separators to generate an electrode assembly, the electrode plates and separators being alternately arranged, the winder being spaced apart from the electrode plates; a cutter having a cutter configured to cut the electrode plates and the separators; and a finisher that is configured to contact the electrode plates and that applies an adhesive material to one end of the electrode plates.

### CROSS-REFERENCE TO RELATED APPLICATION

This application is based on and claims priority under 35 U.S.C. §119 to Korean Patent Application No. 10-2025-0045332, filed on Apr. 8, 2025, in the Korean Intellectual Property Office, the disclosure of which is incorporated by reference herein in its entirety.

### BACKGROUND

### 1. Field

The present disclosure relates to a secondary battery, a secondary battery manufacturing device, and a method of manufacturing a secondary battery.

### 2. Description of the Related Art

Secondary batteries are rechargeable, unlike primary batteries, which are not rechargeable. Low-capacity secondary batteries are used in compact portable electronic devices such as smartphones, feature phones, laptop computers, digital cameras, and camcorders, and large-capacity secondary batteries are widely used as power sources for driving motors in hybrid cars and electric cars and/or used as power storage batteries.

Secondary batteries include an electrode assembly including a positive electrode and a negative electrode, a case for accommodating the electrode assembly, and an electrode terminal connected to the electrode assembly.

A winding process in the secondary battery manufacturing process is a process of forming an electrode assembly by winding electrode plates such as positive and negative electrode plates and one or more separators into a roll shape. Typically, an electrode assembly is finishing-processed after winding is completed, and finish-processing may include attaching a finishing tape to the electrode assembly to prevent loosening of the electrode assembly and to maintain the electrode a shape of the electrode assembly.

The above-described information disclosed in the background art of the present disclosure is merely intended to improve an understanding of the background of the present disclosure and therefore may include information that does not constitute prior art.

### SUMMARY

One or more embodiments provide a secondary battery manufacturing device with which an electrode assembly may be finishing-processed by rotating the electrode assembly and with which a finisher of the secondary battery manufacturing device is able to apply an adhesive material to one end of a first electrode plate that has been cut.

The objectives to be achieved by the present disclosure are not limited to those mentioned above, and other objectives and advantages of the present disclosure that are not mentioned herein may be understood by the following description and will be more clearly understood from embodiments of the present disclosure. Further, the objectives to be solved by the present disclosure and advantages of the present disclosure may be realized by the drawings, the detailed description, and/or the claims.

According to some embodiments of the present disclosure, a secondary battery manufacturing device may include a winder that may be rotatable in one direction and winds electrode plates and separators to generate an electrode assembly, the electrode plates and separators being alternately arranged, the winder being spaced apart from the electrode plates, a cutter having a cutter configured to cut the electrode plates and the separators, and a finisher that may be configured to contact the electrode plates and that applies an adhesive material to one end of the electrode plates.

In some embodiments, the winder may include a base portion that may be rotatable along a preset rotation center axis, and shaft portions that may be rotatably connected to the base portion and that alternately wind the electrode plates and the separators.

In some embodiments, the winder may be rotatable by 120°.

In some embodiments, the finisher may include a finishing body that may be in contact with one end of the electrode plates after the electrode plates may have been cut and may include a suction hole generating negative pressure to suction the electrode plates.

In some embodiments, the secondary battery manufacturing device may further include a plurality of suction holes, wherein the plurality of suction holes may be arranged in an M×N matrix arrangement.

In some embodiments, the finishing body has a spray hole, which the adhesive material passes through, the adhesive material moving toward one end of the electrode plates.

In some embodiments, a region having the spray hole may be positioned farther from the winder than a region having the suction hole.

In some embodiments, the secondary battery manufacturing device may further include a plurality of spray holes, wherein the plurality of spray holes may be spaced apart from each other in a width direction of the finishing body.

In some embodiments, the finisher may further include a spray nozzle configured to send the adhesive material toward the spray hole.

In some embodiments, the secondary battery manufacturing device may further include a supplier configured to provide the electrode plates and the separators to the winder, the supplier configuring the electrode plates and the separators to may have a preset tension when provided to the winder.

According to some embodiments of the present disclosure, a method of manufacturing a secondary battery may include generating, by a winder that may be rotatable in one direction, an electrode assembly by winding electrode plates and separators, which may be alternately arranged and which may be spaced apart from the winder, cutting the electrode plates and the separators after the electrode plates and separators may be wound, and applying an adhesive material to one end of the electrode plates.

In some embodiments, applying the adhesive material to one end of the electrode plates may include generating negative pressure to suction the electrode plates that may have been cut and applying the adhesive material to the electrode plates that may have been suctioned.

In some embodiments, a method of manufacturing a secondary battery may further include rotating the electrode assembly to attach the electrode plates with the adhesive material to an outer surface of the electrode assembly.

In some embodiments, a method of manufacturing a secondary battery may further include performing finishing-processing of the electrode assembly by a finisher, the finisher including a finishing body that may be arranged to be in contact with one end of the cut electrode plates and has a suction hole generating negative pressure to suction the electrode plates.

In some embodiments, a method of manufacturing a secondary battery may further include providing a plurality of suction holes, the suction holes being arranged in an M×N matrix arrangement.

In some embodiments, a method of manufacturing a secondary battery may further include moving the adhesive material through a spray hole positioned in the finishing body and toward one end of the electrode plates.

In some embodiments, a method of manufacturing a secondary battery may further include positioning a region having the spray hole to be farther from the winder than a region having the suction hole.

In some embodiments, a method of manufacturing a secondary battery may further include configuring the winder to be rotatable in increments of 120°.

In some embodiments, a method of manufacturing a secondary battery may further include supplying the electrode plates and the separators to the winder at a preset tension.

According to some embodiments of the present disclosure, a secondary battery manufactured by a method of manufacturing a secondary battery according to some embodiments of the present disclosure may be provided.

### BRIEF DESCRIPTION OF THE DRAWINGS

The drawings attached to the present specification illustrate embodiments of the present disclosure and, together with the detailed description of the present disclosure provided below, serve to further understand the present disclosure; therefore, the present disclosure should not be interpreted as being limited to the matters described in the following drawings.

FIG. 1 is a diagram schematically illustrating a secondary battery manufacturing device according to some embodiments of the present disclosure.

FIG. 2 is a diagram illustrating a first position, a second position, and a third position of an electrode assembly in a winder according to some embodiments of the present disclosure.

FIG. 3 is a diagram illustrating a winder, which winds electrode plates and one or more separators according to some embodiments of the present disclosure.

FIG. 4 is a diagram illustrating a finisher that has suctioned an electrode plate, according to some embodiments of the present disclosure.

FIG. 5 is a diagram illustrating a winder performing finishing-processing of an electrode assembly according to some embodiments of the present disclosure.

FIG. 6 is a plan view of a finisher according to some embodiments of the present disclosure.

FIG. 7 is a cross-sectional view of the finisher with respect to an I-I’ view of FIG. 4 according to some embodiments of the present disclosure.

FIG. 8 is a diagram illustrating an adhesive material applied to a surface of an electrode assembly according to some embodiments of the present disclosure.

FIG. 9 is a flowchart illustrating a method of manufacturing a secondary battery according to some embodiments of the present disclosure.

FIG. 10 is a flowchart of some further operations of the method of manufacturing a secondary battery, shown in FIG. 9, according to some embodiments of the present disclosure.

### DETAILED DESCRIPTION

Hereinafter, embodiments of the present disclosure will be described in detail with reference to the attached drawings. The meaning of the terms used in the present specification and claims of the present disclosure should not be limited to be of ordinary or literary meaning but construed as meanings and concepts not departing from the spirit and scope of the present disclosure based on the principle that the inventor is capable of defining concepts of terms in order to describe his or her disclosure in the most appropriate way. Accordingly, the features disclosed in the preferred embodiments and drawings of the present specification are examples of preferred embodiments of the present disclosure, and thus it should be understood that there are alternative equivalents or variation examples that can replace the preferred embodiments at the point of the filing of the present application.

Additionally, the terms “comprise”, “include,” “comprising,” and/or “including” used herein specify the presence of stated features, numbers, steps, operations, members, components, and/or groups thereof, but do not preclude the presence or addition of one or more other features, numbers, operations, members, components, and/or groups thereof.

Additionally, to aid understanding of the disclosure, the attached drawings are not drawn to scale and the dimensions of some components may be exaggerated. Additionally, the same reference numbers may be assigned to the same components in different embodiments.

When two things being compared are described as ‘the same,’ this indicates that they are ‘substantially the same.’ Therefore, substantial equivalence may include deviations that are considered low in the art, for example, deviations of less than 5%. Additionally, uniformity of a parameter over a given region may imply uniformity from an average perspective.

Although the terms “first, second, etc.” are used to describe various components, these components are not limited by these terms. These terms are only used to distinguish one component from another, and unless otherwise stated, it is of course the case that a first component may also be a second component.

Throughout the specification, unless otherwise specifically stated, each element may be singular or plural.

Any configuration being arranged “above (or below)” a component or “on (or under)” a component may indicate not only that any configuration is arranged in contact with the upper surface (or lower surface) of said component, but also that other configurations may be interposed between said component and any configuration arranged on (or below) said component.

Additionally, when it is described that a component is “linked,” “coupled,” or “connected” to another component, it should be understood that the components may be directly connected or connected to one another, but that other components may also be “interposed” between the components, or that each component may be “linked,” “coupled,” or “connected” through other components. Also, when a part is electrically coupled to another part, this includes not only cases where they are directly connected, but also cases where they are connected with another element in between.

Whenever reference is made throughout the specification to “A and/or B,” this indicates A, B, or A and B, unless otherwise specified. That is, “and/or” includes all or any combination of the listed items. When “C to D” is described, this indicates C or more but not more than D, unless otherwise specified.

The terminology used herein is for the purpose of describing embodiments of the present disclosure and is not intended to be limiting of the present disclosure.

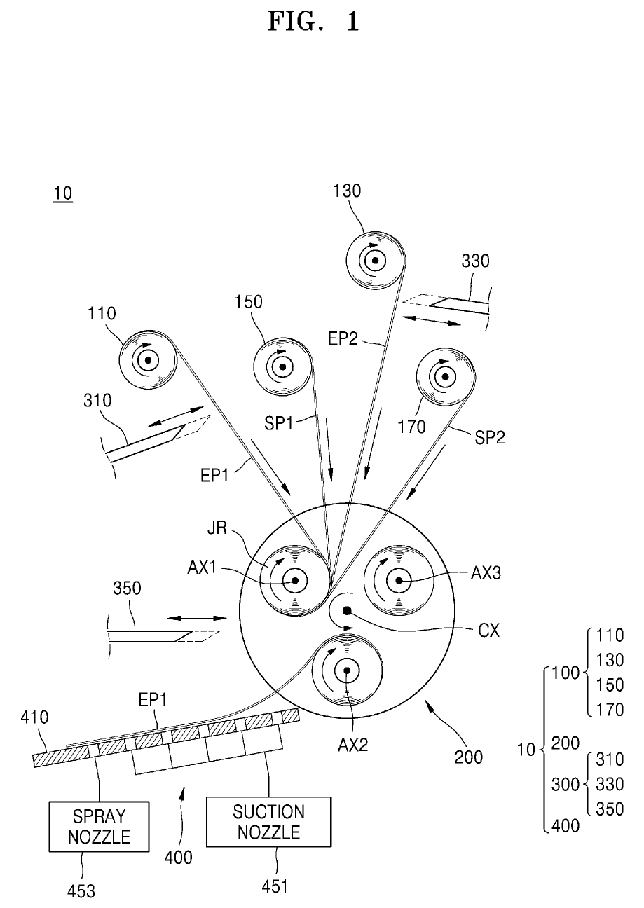

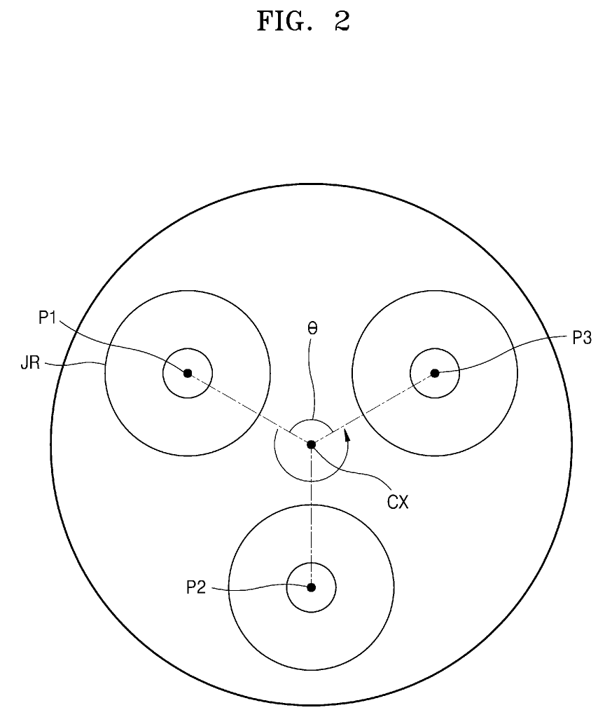

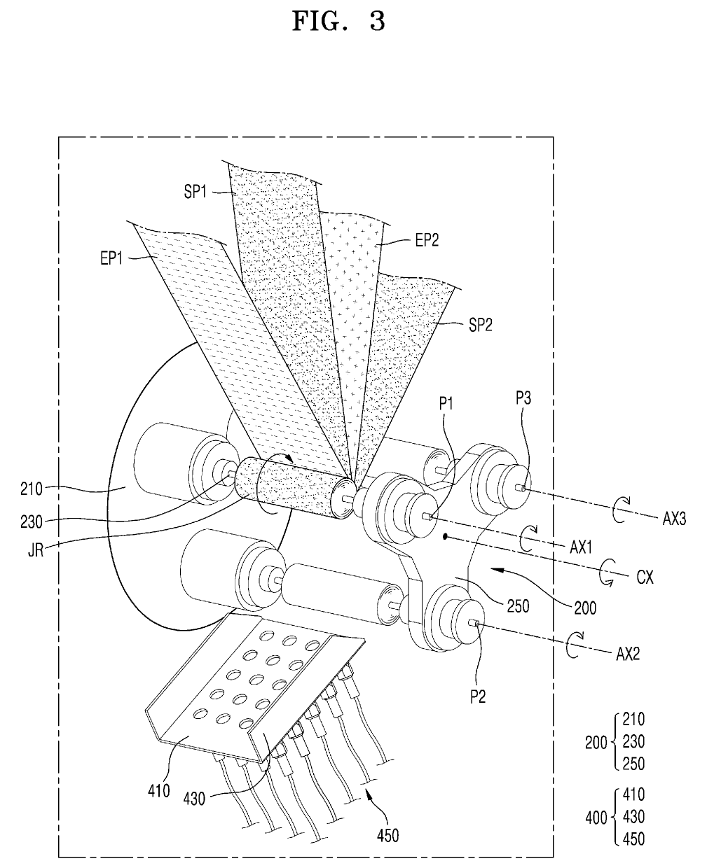

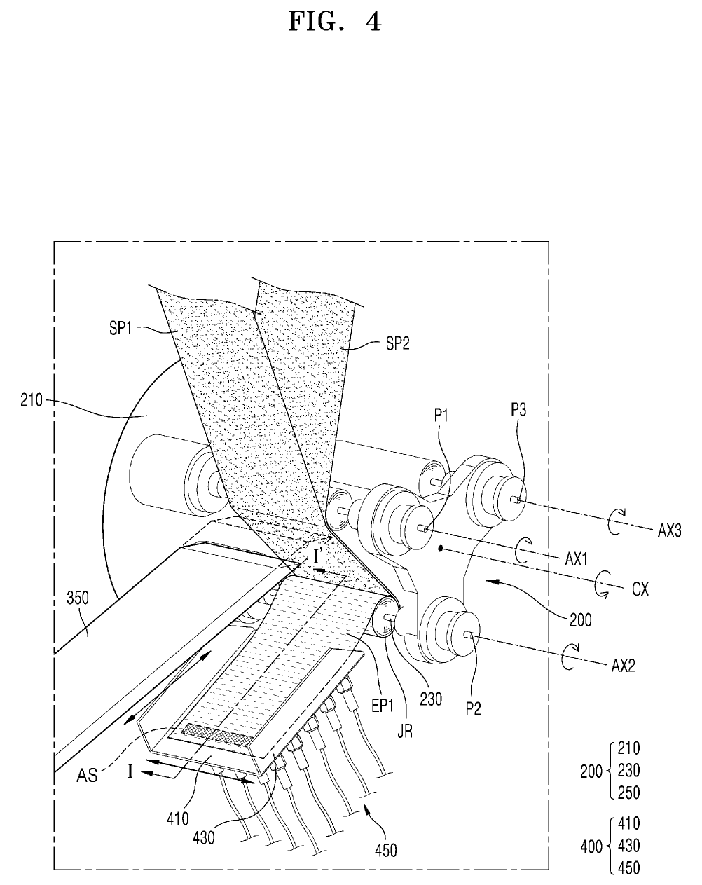

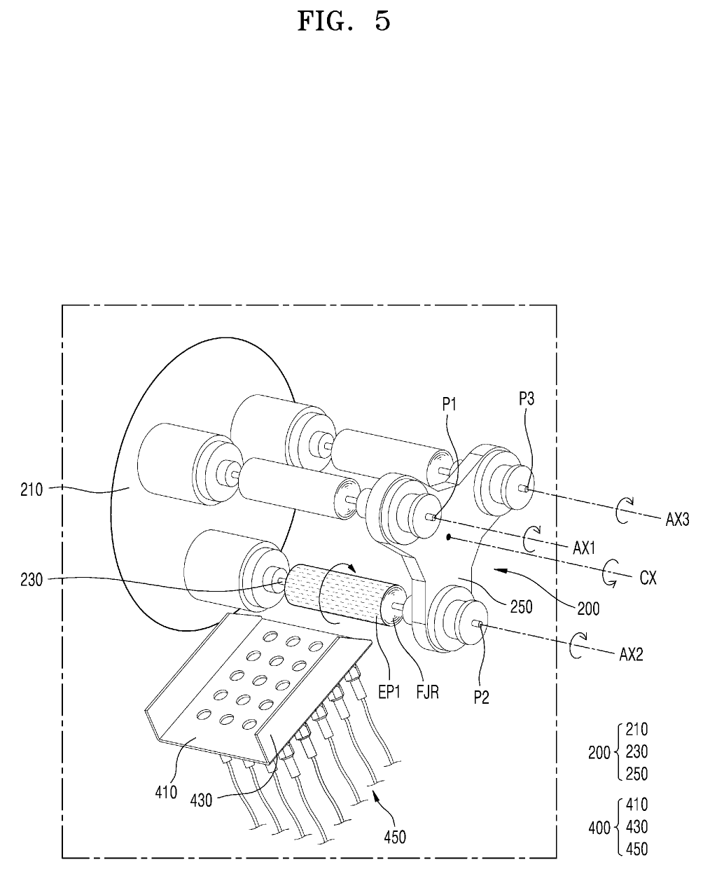

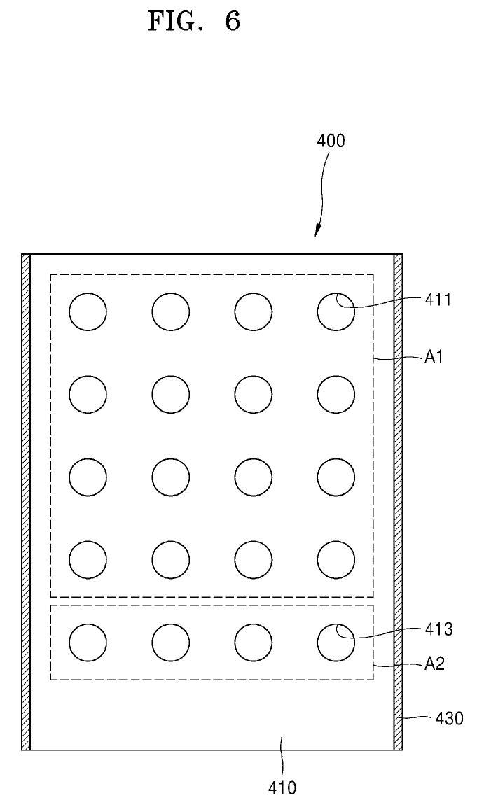

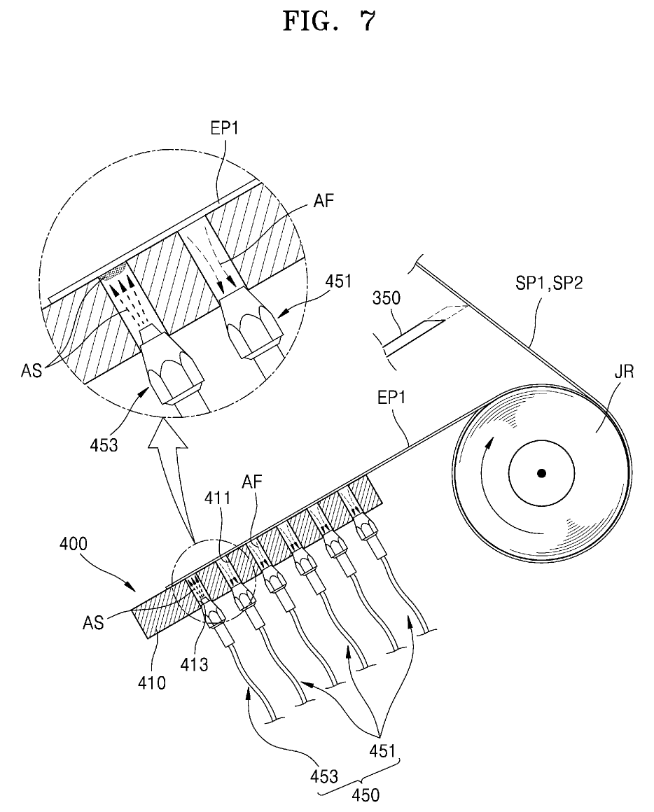

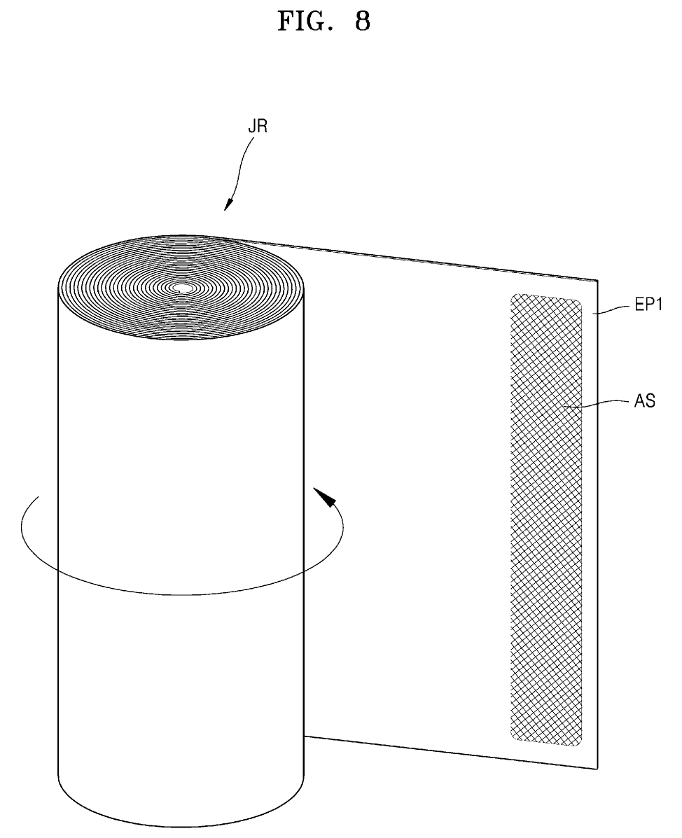

FIG. 1 is a diagram schematically illustrating a secondary battery manufacturing device according to some embodiments of the present disclosure. FIG. 2 is a diagram illustrating a first position, a second position, and a third position of an electrode assembly in a winder according to some embodiments of the present disclosure. FIG. 3 is a diagram illustrating a winder, which winds electrode plates and one or more separators according to some embodiments of the present disclosure. FIG. 4 is a diagram illustrating a finisher that has suctioned an electrode plate, according to some embodiments of the present disclosure. FIG. 5 is a diagram illustrating a winder performing finishing-processing of an electrode assembly according to some embodiments of the present disclosure. FIG. 6 is a plan view of a finisher according to some embodiments of the present disclosure. FIG. 7 is a cross-sectional view of the finisher with respect to an I-I’ view of FIG. 4 according to some embodiments of the present disclosure. FIG. 8 is a diagram illustrating an adhesive material applied to a surface of an electrode assembly according to some embodiments of the present disclosure.

A secondary battery according to some embodiments of the present disclosure may include a rechargeable battery and may include at least one electrode assembly wound with a separator, which is an insulator, between a positive electrode and a negative electrode.

A secondary battery may be manufactured by generating an electrode assembly by arranging a separator between electrode plates formed by applying slurry on a substrate and drying the same, and then winding the electrode plates and the separator, and arranging the electrode assembly in a battery case, spraying an electrolyte, and then sealing the electrode assembly.

Referring to FIGS. 1 to 8, a secondary battery manufacturing device 10 according to some embodiments of the present disclosure manufactures a jelly roll type electrode assembly JR by winding first and second electrode plates EP1 and EP2 and separators SP1, SP2 and may include a supplier 100, a winder 200, a cutter 300, and a finisher 400.

The secondary battery manufacturing device 10 according to some embodiments of the present disclosure may apply an adhesive material AS to one surface of the first electrode plate EP1 that surrounds an outer surface of the electrode assembly JR and may perform finishing-processing of the electrode assembly JR by rotating the electrode assembly JR such that the first electrode plate EP1 is attached to the outer surface of the electrode assembly JR.

In the present specification, the electrode assembly JR may include the first electrode plate EP1, the second electrode plate EP2, and the separators SP1, SP2, and the first electrode plate EP1, the second electrode plate EP2, and the separators SP1, SP2 may be laminated and wound in a form of a jelly roll.

The electrode plates may be manufactured by coating an active material on a metal current collector and may include a first electrode plate EP1 that acts as a negative electrode and a second electrode plate EP2 that acts as a positive electrode. However, the present disclosure is not limited thereto, and a first electrode plate EP1 may act as a positive electrode and a second electrode plate EP2 may act as a negative electrode. However, for convenience of description, in the present specification, the description is based on the assumption that the first electrode plate EP1 is a negative electrode plate and the second electrode plate EP2 is a positive electrode plate.

The first electrode plate EP1 may be formed by applying a first electrode active material, such as graphite or carbon, to a first electrode current collector plate formed of a metal foil, such as copper, a copper alloy, nickel, or a nickel alloy and may include a first uncoated region, which is a region where the first electrode active material is not applied.

The second electrode plate EP2 may be formed by applying a second electrode active material, such as a transition metal oxide, to a second electrode current collector plate formed of a metal foil, such as aluminum or an aluminum alloy and may include a second uncoated region, which is a region where the second electrode active material is not applied.

The separators SP1, SP2 may be arranged between the first electrode plate EP1 and the second electrode plate EP2 and may prevent the first electrode plate EP1 and the second electrode plate EP2 from directly contacting each other and causing a short circuit. The separators SP1, SP2 may include, for example, a polyethylene film, a polypropylene film, a polyethylene-polypropylene film, etc.

The supplier 100 according to some embodiments of the present disclosure may supply the first and second electrode plates EP1, EP2 and the separators SP1, SP2 to the winder 200 at preset tension and may include a first electrode plate supply roll 110, a second electrode plate supply roll 130, and separator supply rolls 150, 170.

Referring to FIG. 1, the first electrode plate supply roll 110 and the second electrode plate supply roll 130 may supply the first electrode plate EP1 and the second electrode plate EP2 to the winder 200, respectively, and the first and second electrode plates EP1 and EP2 wound in a reel shape may be unwound at a preset speed and may be continuously supplied to the winder 200.

The first electrode plate supply roll 110 may supply the first electrode plate EP1 to the winder 200, the second electrode plate supply roll 130 may supply the second electrode plate EP2, and the separator supply rolls 150, 170 may supply the separators SP1, SP2.

According to some embodiments of the present disclosure, the plurality of separator supply rolls 150, 170 may be provided. When there are two separator supply rolls 150, 170, one separator supply roll 170 of the two separator supply rolls 150, 170 may be arranged between the first electrode plate supply roll 110 and the second electrode plate supply roll 130, and the other separator supply roll 150 may be arranged on an outside of the first electrode plate supply roll 110 or an outside of the second electrode plate supply roll 130.

Referring to FIG. 1, a plurality of supply rolls may be arranged in a circumferential direction with respect to a first rotation axis AX1. In some embodiments, the plurality of supply rolls may be arranged in the order of the first electrode plate supply roll 110, the separator supply roll 150, the second electrode plate supply roll 130, and the separator supply roll 170 in a clockwise direction.

Accordingly, the first and second electrode plates EP1, EP2 and the separators SP1, SP2 may be wound in the order of the first electrode plate EP1, the separator SP1, the second electrode plate EP2, and the separator SP2 to form the electrode assembly JR.

Referring to FIGS. 1 to 5, the winder 200 may be rotatable in one direction and may wind first and second electrode plates EP1, EP2 and separators SP1, SP2 that are alternately arranged so as to generate the electrode assembly JR and may include a base portion 210, a shaft portion 230, and a connection portion 250.

According to some embodiments of the present disclosure, the base portion 210 may be rotatable along a preset rotation center axis CX and may rotate by receiving rotational power from an outside source. A plurality of shaft portions 230 may be rotatably connected to the base portion 210.

The shaft portions 230 may extend in a longitudinal direction and the first and second electrode plates EP1, EP2 and the separators SP1, SP2 may be alternately wound therearound, and the shaft portions 230 may be provided in plurality.

The shaft portions 230 may be rotatably connected to the base portion 210. The shaft portions 230 may rotate in one direction at a certain position and wind the first and second electrode plates EP1, EP2 and the separators SP1, SP2 into a jelly roll shape.

As the base portion 210 rotates around the preset rotation center axis CX, the shaft portions 230 may also rotate along the preset rotation center axis CX of the base portion 210. The position of the shaft portions 230 may be changed along the circumference of the base portion 210.

When the electrode assembly JR may be generated in any one shaft portion 230, the base portion 210 may move the electrode assembly JR generated and may rotate so that a process of generating a new electrode assembly JR in another shaft portion 230 may be continuously performed.

For convenience of description, in the present detailed description, it is assumed that three shaft portions 230 are provided in the winder 200 unless otherwise stated.

Referring to FIGS. 1 to 4, the winder 200 may have a first position P1, a second position P2, and a third position P3 that are equiangularly arranged along the circumference with respect to the preset rotation center axis CX. The first position P1, the second position P2, and the third position P3 may be spaced apart from each other by 120°, and respective rotation axes AX1, AX2, and AX3 of the shaft portions 230 may be arranged at the respective positions.

When the winder 200 (i.e., specifically the base portion 210 of the winder 200) rotates, a position of a rotation axis of the shaft portion 230 positioned at the first position P1 may be changed to the second position P2 or the third position P3, and the winder 200 may rotate in increments of 120°.

The rotation axis of the shaft portion 230 rotating at the first position P1 may be defined as the first rotation axis AX1, the rotation axis of the shaft portion 230 rotating at the second position P2 may be defined as the second rotation axis AX2, and the rotation axis of the shaft portion 230 rotating at the third position P3 may be defined as the third rotation axis AX3.

The shaft portions 230 may rotate, and positions of the shaft portions 230 may be switched along the circumferential direction of the base portion 210 based on the preset rotation center axis CX of the base portion 210 and may rotate around any one of the first rotation axis AX1, the second rotation axis AX2, and the third rotation axis AX3 at each position.

In some embodiments, the rotation center axis when the shaft portion 230 is at the first position P1 may be the first rotation axis AX1, the rotation center axis when the shaft portion 230 is at the second position P2 may be the second rotation axis AX2, and the rotation center axis when the shaft portion 230 is at the third position P3 may be the third rotation axis AX3.

Referring to FIGS. 3 to 5, the connection portion 250 may be positioned to face the base portion 210 and the plurality of shaft portions 230 are connected to the connection portion 250, and the connection portion 250 may rotate the shaft portions 230 together with the base portion 210.

The connection portion 250 according to some embodiments of the present disclosure may have a shape of a flat plate and may be a turret.

One end of the shaft portion 230 that is not connected to the base portion 210 may be mounted on the connection portion 250. When ends of the plurality of shaft portions 230 are each mounted on the connection portion 250, the plurality of shaft portions 230 may be arranged on a same plane.

Opposite ends of each of the shaft portions 230 may be supported by the base portion 210 and the connection portion 250, respectively, and, as the base portion 210 and the connection portion 250 rotate simultaneously around the same rotation center axis CX, each shaft portion 230 may rotate in parallel, and a position of each shaft portion 230 may be changed.

Different processes may be performed at respective positions. In some embodiments, at the first position P1, a process of forming the electrode assembly JR by winding the electrode plates and the separators SP1, SP2 may be performed; at the second position P2, finishing-processing the electrode assembly JR (after winding is completed) may be performed; and, at the third position P3, a process of separating a finishing-processed electrode assembly FJR may be performed.

When the electrode assembly JR is generated in the shaft portion 230 positioned at the first position P1, the base portion 210 may rotate 120° to move the shaft portion 230 and the electrode assembly JR to the second position P2, and, when the finishing-processing of the electrode assembly JR is completed at the second position P2, the base portion 210 may rotate 120° to move the shaft portion 230 and the electrode assembly JR to the third position P3.

The electrode assembly JR moved to the third position P3 may be separated and transported by a separate separation device, and then subsequent processes, such as inserting the electrode assembly JR into a battery case, spraying an electrolyte into the battery case, and activating the electrode assembly JR through a charge/discharge process, may be performed.

Processes at respective positions may be performed simultaneously. For example, different processes may be performed simultaneously in the shaft portions 230 positioned at the first position P1, the second position P2, and the third position P3. While the shaft portion 230 positioned at the first position P1 rotates to form an electrode assembly, an electrode assembly positioned at the second position P2 may be finishing-processed, and an electrode assembly positioned at the third position P3 may be separated.

Referring to FIG. 1, FIG. 4, and FIG. 7, the cutter 300 may include a cutter configured to cut the first and second electrode plates EP1, EP2 and may include a first cutter 310, a second cutter 330, and a third cutter 350.

The first cutter 310 may reciprocate in a preset direction to cut the first electrode plate EP1 and may be arranged on one side (left side in FIG. 1) of the first electrode plate supply roll 110 and may be arranged above the winder 200.

The second cutter 330 may reciprocate in a preset direction to cut the second electrode plate EP2, may be arranged on one side (right side in FIG. 1) of the second electrode plate supply roll 130, and may be arranged above the winder 200.

Referring to FIG. 1, the first cutter 310 and the second cutter 330 may be driven to cut the first electrode plate EP1 and the second electrode plate EP2 when the winding of the shaft portion 230 is completed at the first position P1.

The cutting process of the first cutter 310 and the second cutter 330 may be performed when the shaft portion 230 is at the first position P1.

The third cutter 350 may be arranged on one side (left side in FIG. 1) of the winder 200 to reciprocate in a preset direction and cut the separators SP1, SP2. In some embodiments, the third cutter 350 may be positioned between the first position P1 and the second position P2.

Referring to FIG. 4, when the first electrode plate EP1 and the second electrode plate EP2 are cut and the electrode assembly JR and the shaft portion 230 are rotated and moved to the second position P2, the separators SP1, SP2 while being in an uncut state may be positioned between the first position P1 and the second position P2.

With the first electrode plate EP1 that is cut and arranged on the finisher 400, the third cutter 350 may cut the separators SP1, SP2, and, as the shaft portion 230 arranged at the second position P2 rotates, the electrode assembly JR may be finishing-processed.

Referring to FIGS. 1, 3 to 7, the finisher 400 may be configured to contact the first electrode plate EP1 and may perform finishing-processing on the generated electrode assembly JR by applying the adhesive material AS to one end of the first electrode plate EP1, the first electrode plate EP1 being spaced from the winder 200.

In the present specification, the expression “finishing-processing the electrode assembly JR” includes attaching the outer surface of the electrode assembly JR, for which winding is completed, to an inner surface of the first electrode plate EP1 arranged at an outermost side, so that the electrode assembly JR is fixed so as not to come loose.

An electrode assembly JR that has undergone the finishing-processing process and is ready for subsequent processes is defined as a ‘finishing-processed electrode assembly FJR’ to distinguish the same from an electrode assembly JR that is not finish-processed and is rolled up and has a jelly roll shape.

According to some embodiments of the present disclosure, the finisher 400 may be positioned adjacent to the second position P2 of the winder 200. After the winding of the electrode assembly JR is completed at the first position P1, when the electrode assembly JR moves to the second position P2 by the rotation of the base portion 210, one end of the first electrode plate EP1 that is cut may be arranged on the finisher 400.

Referring to FIGS. 7 and 8, the finisher 400 may generate negative pressure AF to suction the first electrode plate EP1 and apply the adhesive material AS to one surface opposite thereto, of the first electrode plate EP1. When the shaft portion 230 rotates around the second rotation axis AX2 while the adhesive material AS is applied, the first electrode plate EP1, after being cut, surrounds around the outer surface of the electrode assembly JR.

The adhesive material AS may be applied to one surface of the first electrode plate EP1, after the first electrode plate EP1 is cut, to attach the first electrode plate EP1 to the outer surface of the electrode assembly JR and may include, for example, an acrylic adhesive material, a silicone adhesive material, a polyurethane adhesive material, a polyimide-based adhesive material, a thermoplastic elastomer, etc. However, the present disclosure is not limited thereto, and the adhesive material AS may be any material that may fix the position of the first electrode plate EP1 on the electrode assembly JR so that the first electrode plate EP1 does not detach from the finishing-processed electrode assembly FJR without reacting with the electrolyte.

One surface of the first electrode plate EP1 to which the adhesive material AS is applied and the outer surface of the electrode assembly JR may be in contact with each other, and the first electrode plate EP1 may be fixed to the electrode assembly JR by the adhesive material AS, and the electrode assembly JR may be finishing-processed.

The finisher 400 according to some embodiments of the present disclosure may include a finishing body 410, a guide wall portion 430, and a nozzle portion 450.

Referring to FIGS. 6 and 7, the finishing body 410 may have a flat plate shape and be positioned to be in contact with one end of the first electrode plate EP1 (which has been cut).

The finishing body 410 according to some embodiments of the present disclosure may have a suction hole 411 suctioning the first electrode plate EP1 by generating the negative pressure AF, and a spray hole 413 through which the adhesive material AS may pass.

In the present specification, one area of the finishing body 410 in which the suction hole 411 is formed may be defined as a first region A1, and another area of the finishing body 410 where the spray hole 413 is formed may be defined as a second region A2.

The suction hole 411 may have a shape of a hole penetrating the finishing body 410 and may be formed with both sides open. The cut first electrode plate EP1 may be arranged on one open side of the suction hole 411, and the nozzle portion 450 to be described later may be connected to the other side of the suction hole 411 to remove air and to generate the negative pressure AF.

The plurality of suction holes 411 may be provided, and the plurality of suction holes 411 may be spaced apart from each other to form an M×N matrix arrangement. The plurality of suction holes 411 may be uniformly distributed over an entire area of the finishing body 410.

The negative pressure AF of a same size may be generated in each suction hole 411. Accordingly, the finishing body 410 may provide a uniform suction force, and one side of the cut first electrode plate EP1 may be evenly suctioned onto the finishing body 410.

In some embodiments, the finishing body 410 may stably suction the first electrode plate EP1 over a relatively large area, and, thus, a position of the first electrode plate EP1 may be fixed without changing even when impact or vibration is applied from an outside source.

Moreover, as the finishing body 410 may cover various areas, the finishing body 410 may be applicable to electrode plates of various sizes.

In some embodiments, the suction holes 411 may be arranged in a 4×4 matrix arrangement. However, the present disclosure is not limited thereto, and the suction holes 411 may be transformed into various arrangements, such as, for example, in any arrangement where uniform suction force is provided over a wide area.

Referring to FIG. 4, when the electrode assembly JR, for which winding is completed, moves from the first position P1 to the second position P2, the first electrode plate EP1 may be attached to the finishing body 410.

A surface of the first electrode plate EP1 may be smoothly spread out without wrinkles or bubbles, identical to the shape of the finishing body 410. When the electrode assembly JR rotates around the second rotation axis AX2, the first electrode plate EP1 may be smoothly wound around the electrode assembly JR in a flat state.

Referring to FIG. 6 and FIG. 7, the finishing body 410 may have the spray hole 413 through which the adhesive material AS may pass toward one end of the first electrode plate EP1.

The spray hole 413 may have a shape of a hole penetrating the finishing body 410 and may be formed with both sides open. The first electrode plate EP1 may be arranged on one open side of the spray hole 413, and the nozzle portion 450 may be arranged on the other side to spray the adhesive material AS into the spray hole 413.

The adhesive material AS may flow through the spray hole 413 and may be applied to the first electrode plate EP1 suctioned on the finishing body 410.

According to some embodiments of the present disclosure, the spray hole 413 may be spaced apart from the winder 200 more than the suction hole 411 is spaced apart from the winder 200. The spray hole 413 may be positioned on the finishing body 410 farther away from the second position P2 than the suction hole 411 is positioned on the finishing body 410. The second region A2 may be positioned farther away from the winder 200 than the first region A1.

When the first electrode plate EP1 is suctioned onto the finishing body 410, the spray hole 413 may be positioned to face the end of the first electrode plate EP1. The suction hole 411 may be positioned to face an area relatively closer to an inside than an end of the first electrode plate EP1.

When the first electrode plate EP1, after being cut, is suctioned by the spray hole 413 and fixed in position on the finishing body 410, the adhesive material AS may pass through the spray hole 413 and may be applied to an end of the first electrode plate EP1.

When the shaft portion 230 is rotated around the second rotation axis AX2 after the adhesive material AS is applied, the first electrode plate EP1 may be attached to surround the outer surface of the electrode assembly JR.

The plurality of spray holes 413 are provided, and the plurality of spray holes 413 may be spaced apart in a width direction of the finishing body 410.

The spray holes 413 may be provided in a same number as a number of rows of the suction holes 411 and may be spaced apart from each other at a same interval as an interval between each row.

When the plurality of suction holes 411 are arranged in a 4×4 matrix arrangement, the spray holes 413 may be arranged in a 1×4 matrix arrangement.

Since the plurality of spray holes 413 are spaced apart from each other in the width direction of the finishing body 410, the adhesive material AS may be applied to the first electrode plate EP1 in a direction parallel to a width direction of the first electrode plate EP1. Accordingly, the first electrode plate EP1 may be evenly attached to the outer surface of the electrode assembly JR in the width direction and may be stably fixed to the electrode assembly JR.

Referring to FIG. 6, the second region A2 may be smaller than the first region A1. When the suction hole 411 arranged in the first region A1 suctions the first electrode plate EP1 over a wide area, the spray hole 413 arranged in the second region A2 may spray the adhesive material AS only to the end of the first electrode plate EP1.

Referring to FIGS. 1 and 3 to 7, a pair of guide wall portions 430 may be provided on opposite sides of the finishing body 410 and may guide a position at which the first electrode plate EP1 is suctioned, thereby aligning the positions of the cut first electrode plate EP1 and the electrode assembly JR.

In some embodiments, the guide wall portion 430 may align a widthwise center of the first electrode plate EP1 when the cut first electrode plate EP1 is suctioned onto the finishing body 410. Two edges of the first electrode plate EP1 may be arranged parallel to the pair of guide wall portions 430 arranged on each side.

This may prevent the first electrode plate EP1 from moving in the width direction due to external vibration or impact during a winding process. In some embodiments, when the first electrode plate EP1 receives an impact from an outside source, the guide wall portion 430 may protect the opposite edges of the first electrode plate EP1, thereby minimizing damage to the first electrode plate EP1.

According to some embodiments of the present disclosure, as the finisher 400 is provided, the finishing body 410 may generate the negative pressure AF to suction the first electrode plate EP1, dust and residue generated when cutting the first electrode plate EP1 may be removed, and the first electrode plate EP1 may be smoothly wound around the outer surface of the electrode assembly JR without being wrinkled or crumpled.

In some embodiments, since the finishing body 410 applies the adhesive material AS to the end of the first electrode plate EP1 while the cut first electrode plate EP1 is suctioned, the first electrode plate EP1 may be wound around and adhered to the electrode assembly JR simply by rotating the shaft portion 230, thereby providing an effect of finishing-processing the electrode assembly JR.

In some embodiments, the finishing body 410 may align the widthwise center of the cut first electrode plate EP1 with a widthwise center of the electrode assembly JR and may prevent a short circuit from occurring due to the cut first electrode plate EP1 being misaligned and attached to the outer surface of the electrode assembly JR.

Referring to FIGS. 3 to 7, the nozzle portion 450 may be arranged on one surface of the finishing body 410 where the first electrode plate EP1 is not arranged and may include a suction nozzle 451 and a spray nozzle 453.

The suction nozzle 451 according to some embodiments of the present disclosure may remove air to generate a vacuum or negative pressure AF and may be arranged on one open side of the suction hole 411. In some embodiments, the suction nozzle 451 may be arranged on the other surface of the finishing body 410, the other surface facing the one surface of the finishing body 410, on which the first electrode plate EP1 is arranged.

According to some embodiments of the present disclosure, a plurality of suction nozzles 451 may be provided, and the plurality of suction nozzles 451 may be provided at positions corresponding to positions of the plurality of suction holes 411.

If the suction holes 411 are arranged in a 4×4 matrix arrangement, 16 suction nozzles 451 may also be provided and connected to the suction hole 411, the 16 suction nozzles 451 having a 4×4 matrix arrangement.

As a suction force is generated in each of the plurality of suction holes 411, the first electrode plate EP1 may be uniformly suctioned onto the finishing body 410.

Referring to FIG. 7, the spray nozzle 453 may supply the adhesive material AS toward the spray hole 413 and may be arranged on one open side of the spray hole 413. In some embodiments, the spray nozzle 453 may be arranged on the other surface of the finishing body 410, the other surface facing the one surface of the finishing body 410, on which the first electrode plate EP1 is arranged.

According to some embodiments of the present disclosure, a plurality of spray nozzles 453 are provided, and the plurality of spray nozzles 453 may be provided at positions respectively corresponding to the positions of the plurality of spray holes 413.

When the plurality of spray holes 413 are spaced apart in the width direction of the finishing body 410, the plurality of spray nozzles 453 may also be correspondingly arranged in the width direction of the finishing body 410.

At least some of the spray nozzles 453 may be arranged inwards relative to the spray holes 413. When the spray nozzle 453 sprays the adhesive material AS at a preset pressure, the adhesive material AS may pass through the spray hole 413 and be applied to the first electrode plate EP1.

Since the plurality of spray nozzles 453 are spaced apart from each other in the width direction of the finishing body 410, and the adhesive material AS may be evenly applied in the width direction of the finishing body 410 and/or in a width direction of the cut first electrode plate EP1.

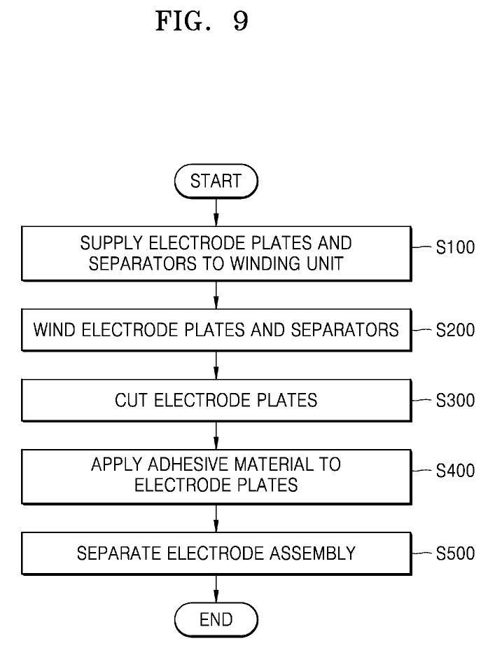

FIG. 9 is a flowchart illustrating a method of manufacturing a secondary battery according to some embodiments of the present disclosure.

A method of manufacturing a secondary battery, according to some embodiments of the present disclosure, may include operation S100 of supplying electrode plates and separators to a winder with preset tension, operation S200 of generating an electrode assembly by using a winder that is rotatable in one direction and winds the electrode plates and the separators which are alternately arranged, operation S300 of cutting the electrode plates (of which winding has been completed), operation S400 of applying an adhesive material to one end of the electrode plates spaced apart from the winder, and operation S500 of separating the electrode assembly from the winder after the electrode assembly has been finish-processed.

The secondary battery manufacturing device 10 according to some embodiments of the present disclosure may include the supplier 100, the winder 200, the cutter 300, and the finisher 400.

Referring to FIG. 1 and FIG. 9, operation S100 of supplying the electrode plates and the separators to the winder at a preset tension may be an operation in which the supplier 100 alternately arranges the first electrode plate EP1, the second electrode plate EP2 and the separators SP1, SP2 through a plurality of supply rolls and supplies the same to the winder 200.

In some embodiments, the first electrode plate EP1, the second electrode plate EP2, and the separators SP1, SP2 may be supplied to the shaft portion 230, which rotates at the first position P1.

A tension measuring sensor (not shown) may be installed on the plurality of supply rolls and may be equipped with tension. The tension measuring sensor may detect, in real time, tension of the first and second electrode plates EP1, EP2 and the separators SP1, SP2 supplied to the winder 200.

Accordingly, the tension of the first and second electrode plates EP1, EP2 and the separators SP1, SP2 may be corrected in real time, and damage to the first and second electrode plates EP1, EP2 due to excessive tension or wrinkles or crumpling to or in the first and second electrode plates EP1, EP2 due to too low tension may be prevented. In some embodiments, the first and second electrode plates EP1, EP2 and the separators SP1, SP2 forming the electrode assembly JR may be aligned and pressed in a uniform manner in the width direction.

Referring to FIGS. 1, 3, and 9, operation S200 of generating an electrode assembly by using a winder, which is rotatable in one direction and which winds the electrode plates and the separators (which are alternately arranged), may be an operation in which the shaft portion 230 rotates about the first rotation axis AX1 relative to the base portion 210 to wind the electrode plates and the separators SP1, SP2 and to generate the electrode assembly JR.

Operation S200 of generating an electrode assembly may be performed at the first position P1 of the winder 200.

Operation S100 of supplying the electrode plates and the separators and operation S200 of generating the electrode assembly may be performed simultaneously. The winder 200 may wind, in real time, the first and second electrode plates EP1, EP2 and the separators SP1, SP2 supplied from the supplier 100 to generate the electrode assembly JR.

Referring to FIG. 1 and FIG. 9, operation S300 of cutting an electrode plate for which winding is completed may be performed by the first cutter 310 and the second cutter 330.

When the shaft portion 230 of the first position P1 completes winding by rotating a preset number of rotations, the electrode plate may be cut. In some embodiments, the first cutter 310 positioned on the left (based on FIG. 1) relative to the first position P1 may cut the first electrode plate EP1, and the second cutter 330 positioned on the right (based on FIG. 2) relative to the first position P1 may cut the second electrode plate EP2.

Operation S300 of cutting the electrode plate for which winding is completed may be performed when a rotation center axis of the shaft portion 230 is the first rotation axis AX1, such as when the shaft portion 230 is at the first position P1.

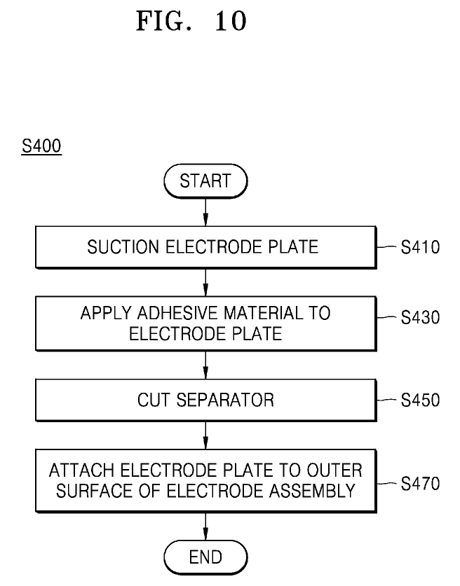

FIG. 10 is a flowchart of some further operations of the method of manufacturing a secondary battery, shown in FIG. 9, according to some embodiments of the present disclosure.

Operation S400 of applying an adhesive material to one end of an electrode plate that is spaced apart from the winder may be performed while the shaft portion 230 and the electrode assembly JR at the first position P1 are rotated by the base portion 210 and moved to the second position P2.

Operation S400 of applying an adhesive material to one end of the electrode plate spaced apart from the winder, according to some embodiments of the present disclosure, may include operation S410 of suctioning a cut electrode plate by generating a negative pressure, operation S430 of applying an adhesive material to the suctioned electrode plate, operation S450 of cutting a separator, and operation S470 of attaching the electrode plate (via the adhesive material) to an outer surface of the electrode assembly by rotating the electrode assembly.

Referring to FIG. 4 and FIG. 7, operation S410 of suctioning the cut electrode plate by generating negative pressure may be an operation in which the finisher 400 generates the negative pressure AF to suction, on one surface of the first electrode plate EP1, the first electrode plate EP1.

When the suction nozzle 451 arranged on one surface (bottom surface as shown in FIG. 7) of the finishing body 410 generates the negative pressure AF to provide a suction force, the first electrode plate EP1 (after being cut) may be arranged on the other surface (top surface as shown in FIG. 7) of the finishing body 410 by the suction force.

The first electrode plate EP1 may be suctioned onto the finishing body 410 in a uniformly spread state, and the widthwise center of the first electrode plate EP1 may be aligned by the guide wall portion 430. In some embodiments, dust, dirt, etc. generated during the cutting process may be removed due to the suction force of the finishing body 410.

Referring to FIG. 4 and FIG. 7, operation S430 of applying an adhesive material to the suctioned electrode plate may be an operation in which an adhesive material AS sprayed from a spray nozzle 453 passes through a spray hole 413 and is applied to one surface of the first electrode plate EP1.

While the first electrode plate EP1 is suctioned onto the finishing body 410, the end of the first electrode plate EP1 may be arranged to face the spray hole 413. The spray hole 413 and the spray nozzle 453 may be spaced apart from each other in the width direction of the first electrode plate EP1. Thus, the adhesive material AS may be applied in the width direction of the first electrode plate EP1.

When the adhesive material AS is applied, as the suction hole 411 suctions the first electrode plate EP1, the first electrode plate EP1 may be stably fixed on the finishing body 410 without being pushed out or moved by the pressure applied by the spray nozzle 453.

Referring to FIG. 1, FIG. 4, and FIG. 7, operation S450 of cutting the separators may be performed by the third cutter 350. The third cutter 350 may be positioned between the first position P1 and the second position P2 and may cut the separators SP1, SP2 positioned between the first position P1 and the second position P2 when the electrode assembly JR and the shaft portion 230 are moved from the first position P1 to the second position P2.

Referring to FIG. 4, the length of the separators SP1, SP2 cut at the second position P2 may be relatively shorter than the length of the first electrode plate EP1 cut at the first position P1. Accordingly, when the shaft portion 230 rotates at the second position P2 to finish-process the electrode assembly JR, the first electrode plate EP1 may be arranged on the outer surface of the electrode assembly JR.

Referring to FIG. 5, operation S470 of attaching an electrode plate coated with an adhesive material to an outer surface of the electrode assembly, by rotating the electrode assembly, may be an operation in which the shaft portion 230 rotates at the second position P2 so that the first electrode plate EP1, the second electrode plate EP2, and the separators SP1, SP2 that are cut are wound around the outer surface of the electrode assembly JR.

Among the first electrode plate EP1, the second electrode plate EP2, and the separators SP1, SP2, which are each cut, the length of the first electrode plate EP1 may be longest. Accordingly, the first electrode plate EP1 may be arranged on the outermost side of the finishing-processed electrode assembly FJR.

Referring to FIG. 8, when the electrode assembly JR rotates, the adhesive material AS may be applied to one surface of the first electrode plate EP1, the surface facing the outer surface of the electrode assembly JR.

The electrode assembly JR may rotate by the rotation of the shaft portion 230, and the first electrode plate EP1 arranged in the finisher 400 may rotate simultaneously and may surround the outer surface of the electrode assembly JR.

At the same time, the end of the first electrode plate EP1 (which has been cut) may contact and be bonded to the outer surface of the electrode assembly JR, and, thus, an end of the electrode assembly JR, when the electrode assembly JR is being finish-processed, may be fixed without loosening, thereby completing the finishing process.

Referring to FIG. 1 and FIG. 10, operation S500 of separating the finishing-processed electrode assembly from the winder 200 may be performed when the rotation center axis of the shaft portion 230 is the third rotation axis AX3, such as, for example, when the shaft portion 230 is at the third position P3.

The finishing-processed electrode assembly FJR and the shaft portion 230 may be rotated by the base portion 210 and may be moved to the third position P3. A separation device may be arranged on one side (for example, the right side in FIG. 1) of the winder 200, and the finishing-processed electrode assembly FJR may be separated and moved to a subsequent process.

Afterwards, processes such as inserting the finishing-processed electrode assembly FJR into a battery case, spraying an electrolyte into the battery case, and/or activating the finishing-processed electrode assembly FJR through a charge/discharge process may be performed.

In secondary battery manufacturing devices according to the related art, an electrode assembly for which winding is completed was finishing-processed by wrapping the outer side of the electrode assembly with a finishing tape. An issue arose complicating the manufacturing process, in that a separate device was required to attach the finishing tape.

Moreover, when the finishing tape is formed of a material that dissolves in the electrolyte, the finishing tape flows down and blocks the pores of the separator, causing a short circuit. When the finishing tape is made of a material that does not dissolve in the electrolyte, there may be a problem of which the finishing tape forms steps with the inner wall of the battery case, causing an end-of-winding crack.

According to the secondary battery manufacturing device of some embodiments of the present disclosure, an electrode assembly may be finishing-processed by rotating the electrode assembly without having to separately attach a finishing tape, insofar as a finisher that suctions a first electrode plate (which has been cut) applies an adhesive material to an end of the electrode plates.

If no tape is used for finishing-processing, stability of the secondary battery may be improved and the occurrence of cracks at the end of a roll of an electrode assembly due to the steps formed by the tape may be minimized.

However, the effects that may be obtained through the present disclosure are not limited to the effects described above, and other technical effects not mentioned will be clearly understood by those skilled in the art from the description of the present disclosure.

Although the present disclosure has been described above by means of limited embodiments and drawings, the present disclosure is not limited thereto, and various modifications and variations may be possible by those skilled in the art.

What is claimed is:

1. A secondary battery manufacturing device comprising:
a winder that is rotatable in one direction and winds electrode plates and separators to generate an electrode assembly, the electrode plates and separators being alternately arranged, the winder being spaced apart from the electrode plates;
a cutter having a cutter configured to cut the electrode plates and the separators; and
a finisher that is configured to contact the electrode plates and that applies an adhesive material to one end of the electrode plates at a position spaced apart from the winder.

2. The secondary battery manufacturing device of claim 1, wherein the winder comprises:
a base portion that is rotatable along a preset rotation center axis; and
shaft portions that are rotatably connected to the base portion and that alternately wind the electrode plates and the separators.

3. The secondary battery manufacturing device of claim 1, wherein the winder is rotatable by 120°.

4. The secondary battery manufacturing device of claim 1, wherein the finisher includes a finishing body that is in contact with one end of the electrode plates after the electrode plates have been cut and includes a suction hole generating negative pressure to suction the electrode plates.

5. The secondary battery manufacturing device of claim 4, further comprising a plurality of suction holes, wherein the plurality of suction holes are arranged in an M×N matrix arrangement.

6. The secondary battery manufacturing device of claim 4, wherein the finishing body has a spray hole, which the adhesive material passes through, the adhesive material moving toward one end of the electrode plates.

7. The secondary battery manufacturing device of claim 6, wherein a region having the spray hole is positioned farther from the winder than a region having the suction hole.

8. The secondary battery manufacturing device of claim 6, further comprising a plurality of spray holes, wherein the plurality of spray holes are spaced apart from each other in a width direction of the finishing body.

9. The secondary battery manufacturing device of claim 6, wherein the finisher further comprises a spray nozzle configured to send the adhesive material toward the spray hole.

10. The secondary battery manufacturing device of claim 1, further comprising a supplier configured to provide the electrode plates and the separators to the winder, the supplier configuring the electrode plates and the separators to have a preset tension when provided to the winder.

11. A method of manufacturing a secondary battery comprising:
generating, by a winder that is rotatable in one direction, an electrode assembly by winding electrode plates and separators, which are alternately arranged and which are spaced apart from the winder;
cutting the electrode plates and the separators after the electrode plates and separators are wound; and
applying an adhesive material to one end of the electrode plates at a position spaced apart from the winder.

12. The method of manufacturing a secondary battery of claim 11, wherein applying the adhesive material to one end of the electrode plates comprises:
generating negative pressure to suction the electrode plates that have been cut; and
applying the adhesive material to the electrode plates that have been suctioned.

13. The method of manufacturing a secondary battery of claim 12, further comprising rotating the electrode assembly to attach the electrode plates with the adhesive material to an outer surface of the electrode assembly.

14. The method of manufacturing a secondary battery of claim 11, further comprising performing finishing-processing of the electrode assembly by a finisher, the finisher including a finishing body that is arranged to be in contact with one end of the cut electrode plates and has a suction hole generating negative pressure to suction the electrode plates.

15. The method of manufacturing a secondary battery of claim 14, further comprising providing a plurality of suction holes, the suction holes being arranged in an M×N matrix arrangement.

16. The method of manufacturing a secondary battery of claim 14, further comprising moving the adhesive material through a spray hole positioned in the finishing body and toward one end of the electrode plates.

17. The method of manufacturing a secondary battery of claim 16, wherein the spray hole is positioned farther from the winder than the suction hold is positioned from the winder.

18. The method of manufacturing a secondary battery of claim 11, further comprising configuring the winder to be rotatable in increments of 120°.

19. The method of manufacturing a secondary battery of claim 11, further comprising supplying the electrode plates and the separators to the winder at a preset tension.

20. A secondary battery manufactured by the manufacturing method according to claim 11.
